(19) United States
(12) Patent Application Publication
(10) Pub. No.: US 2021/0090161 A1
(43) Pub. Date: Mar. 25, 2021

(54) CRITERIA PAY RETURN SYSTEM AND METHOD

(71) Applicant: Wells Fargo Bank, N.A., Charlotte, NC (US)

(72) Inventors: Stephanie Chen, Oakland, CA (US); Burtt Blodgett, Mill Valley, CA (US)

(21) Appl. No.: 15/092,169

(22) Filed: Apr. 6, 2016

(51) Int. Cl. G06Q 40/02

(52) U.S. Cl. CPC G06Q 40/025

(57) ABSTRACT

A system and method of determining overdraft tolerances is disclosed that includes a segment decision component that assigns a bank account to a risk segment, a score calculation component that calculates a daily risk score for the bank account, an assignment component that assigns the bank account to a risk group within the risk segment, and an overdraft tolerance component that assigns an overdraft tolerance to the bank account.

### BACKGROUND

When a consumer has insufficient funds in a Demand Deposit Account (DDA), the bank must make a decision to authorize or decline a transaction intra-day and to pay or return a transaction when it is submitted to the bank for payment. If a customer meets bank eligibility for a courtesy overdraft amount (called an “overdraft tolerance”), then the bank may authorize or pay these transactions into overdraft to satisfy customer payment needs and to reduce the cost and impact of transactions returned unpaid. Unfortunately, a portion of the customers who have transactions authorized and paid into overdraft never repay the overdrawn amounts in full. The bank must charge-off the negative balance and absorb the loss after the account is consecutively overdrawn for 60 days.

The payment of an overdraft is discretionary, and the bank has no obligation to authorize or pay transactions into overdraft. The bank reviews individual customer accounts periodically to determine whether the customer continues to qualify for the amount of overdraft tolerance provided. Automation is used to apply specific bank criteria for determining whether an account should be eligible for overdraft services and how to set overdraft tolerance.

### SUMMARY

The following presents a simplified summary of the innovation in order to provide a basic understanding of some aspects of the innovation. This summary is not an extensive overview of the innovation. It is not intended to identify key/critical elements of the innovation or to delineate the scope of the innovation. Its sole purpose is to present some concepts of the innovation in a simplified form as a prelude to the more detailed description that is presented later.

An improved system and method of addressing overdraft tolerances is disclosed. The improved system and method provides decision variables and associated model weights that are used to dynamically calculate a risk score (e.g., daily risk score). In one example, the model weights are multiplied by daily values of each associated decision variable based on account activity. This product is added to a numeric intercept to determine the daily risk score for that account. The daily risk score is compared to a daily risk score threshold to assign the account to a risk group within a risk segment, which contains an overdraft tolerance for that account for a given day. The model weights are calculated via a regression analysis, which predicts, with a degree of certainty, the relationship between the decision variables and how a value of one or more decision variables is affected when one or more other decision variables change.

An aspect relates to a method of determining an overdraft tolerance that includes assigning, by a system comprising a processor, an account to one of a plurality of risk segments, calculating a daily risk score for the account, assigning the account to one of a plurality of risk groups in the associated one of the plurality of segments based on the daily risk score, and assigning an overdraft tolerance to the account.

Another aspect relates to a system and method of determining overdraft tolerances that includes a segment decision component that assigns a bank account to a risk segment, a score calculation component that calculates a daily risk score for the bank account, an assignment component that assigns the bank account to a risk group within the risk segment, and an overdraft tolerance component that assigns an overdraft tolerance to the bank account.

Another aspect relates to a system and method that includes a computer-readable storage device storing executable instructions that, in response to execution, cause a system comprising a processor to perform operations that includes determining a plurality of decision variables associated with a criteria pay bank account, assigning a value to each of the plurality of decision variables, performing an IF-THEN iteration to the plurality of decision variables to thereby assign the criteria bank account to one of a plurality of risk segments, calculating model weights for each of the plurality of decision variables, calculating a decision variable score for each of the plurality of decision variables by multiplying the model weights by the value of an associated decision variable from the plurality of decision variables, summing the decision variable score for each of the plurality of decision variables, adding a numeric intercept to the sum of the decision variable score for each of the plurality of decision variables thereby determining a daily risk score, comparing the daily risk score to a daily risk score threshold, and assigning an overdraft tolerance to the bank account.

To the accomplishment of the foregoing and related ends, certain illustrative aspects of the innovation are described herein in connection with the following description and the annexed drawings. These aspects are indicative, however, of but a few of the various ways in which the principles of the innovation may be employed and the subject innovation is intended to include all such aspects and their equivalents. Other advantages and novel features of the innovation will become apparent from the following detailed description of the innovation when considered in conjunction with the drawings.

### BRIEF DESCRIPTION OF THE DRAWINGS

FIGS. 1 and 2 are non-limiting illustrations of an overdraft tolerance system shown in block diagram and flow chart forms respectively, according to an aspect.

FIGS. 3 and 4 illustrate example, non-limiting block diagrams of a method of determining overdraft tolerances for a bank account, according to an aspect.

FIG. 5 illustrates an example, non-limiting computer-readable medium or computer-readable device including processor-executable instructions configured to embody one or more of the aspects set forth herein.

FIG. 6 illustrates an example, non-limiting computing environment where one or more of the aspects set forth herein are implemented, according to one or more aspects.

### DETAILED DESCRIPTION

The innovation is now described with reference to the drawings. In the following description, for purposes of explanation, numerous specific details are set forth in order to provide a thorough understanding of the subject innovation. It may be evident, however, that the innovation may be practiced without these specific details. In other instances, well-known structures and devices are shown in block diagram form in order to facilitate describing the innovation.

As used herein, the term “inference” or “infer” refers generally to the process of reasoning about or inferring states of the system, a component, a module, the environment, and/or user devices from a set of observations as captured through events, reports, data and/or through other forms of communication. Inference may be employed to identify a specific context or action, or may generate a probability distribution over states, for example. The inference may be probabilistic such as for example, computation of a probability distribution over states of interest based on a consideration of data and/or events. The inference may also refer to techniques employed for composing higher-level events from a set of events and/or data. Such inference may result in the construction of new events and/or actions from a set of observed events and/or stored event data, whether or not the events are correlated in close temporal proximity, and whether the events and/or data come from one or several events and/or data sources. Various classification schemes and/or systems (e.g., support vector machines, neural networks, logic-centric production systems, Bayesian belief networks, fuzzy logic, data fusion engines, and so on) may be employed in connection with performing automatic and/or inferred action in connection with the disclosed aspects.

Disclosed herein is a system and method (Criteria Pay Return Model) that utilizes account data to calculate daily overdraft tolerances for the bank's retail qualified DDAs in accordance with an aspect of the innovation. The Criteria Pay Return Model calculates the overdraft tolerance for DDAs during nightly batch posting and real-time (or near real-time) electronic item authorization, and makes decisions on whether or not to authorize and pay items submitted for payment where the account has insufficient funds or to decline and return the items. The Criteria Pay Return Model uses predictive science to assess the risk of each transaction that allows dynamic assignment of the overdraft tolerance thus, improving operation efficiency while managing overdraft exposures to the bank. The Criteria Pay Return Model is implemented through Process Control Data (PCD) tables, allowing new overdraft tolerances to be easily deployed by changing model weights and segmentations in PCDs, alleviating a need for complex programming or coding, and improving the cost effectiveness of deployment of business strategies.

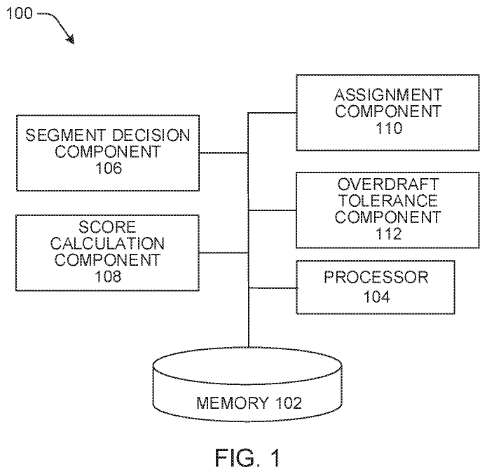

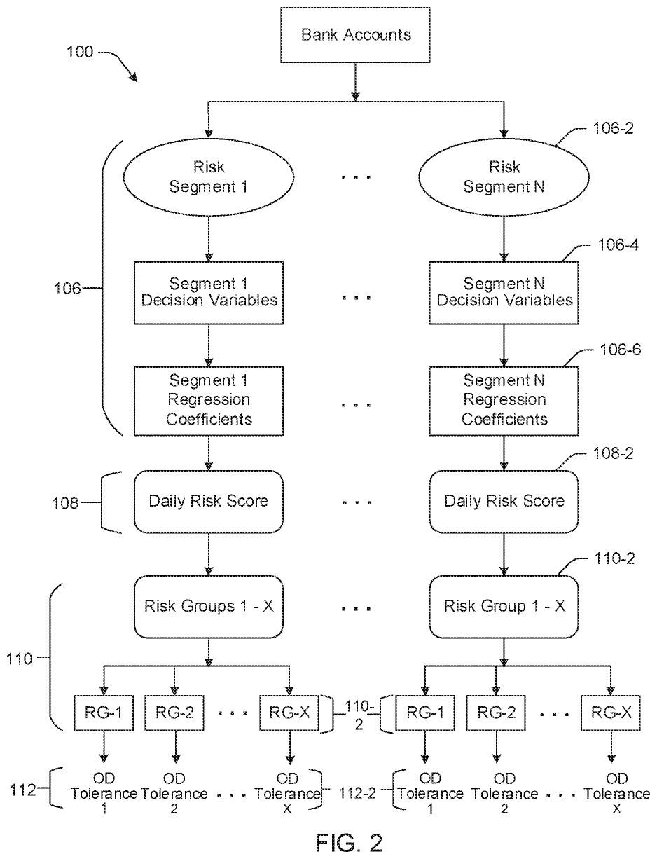

Referring now to the drawings, FIGS. 1 and 2 are illustrations of an overdraft tolerance system 100 shown in block diagram and flow chart forms respectively that assigns accounts to a risk group based on a daily calculated score in accordance with an aspect of the innovation. As mentioned above, the Criteria Pay Return Model utilizes predictive science and variety of statistical methods to determine a daily risk score and assign an account an overdraft tolerance based on the daily risk score. While “daily” iterations are used in the described embodiments, it is to be understood that alternative periods (e.g., multiple days, weeks, months, etc.) can be employed without departing from the spirit and/or scope of the innovation and claims appended hereto. Additionally, in alternative aspects, scores, thresholds, etc. can be triggered based upon a defined number of transactions or actions as desired. These alternative aspects are to be included within the scope of the innovation described herein.

Referring to FIG. 1, the system 100 may include at least one memory 102 that may store computer executable components and/or computer executable instructions. The system 100 may also include at least one processor 104, communicatively coupled to the at least one memory 102. The at least one processor 104 may facilitate execution of the computer executable components and/or the computer executable instructions stored in the memory 102. The term “coupled” or variants thereof may include various communications including, but not limited to, direct communications, indirect communications, wired communications, and/or wireless communications (e.g., with specialized banking machines and systems).

It is noted that although the one or more computer executable components and/or computer executable instructions may be illustrated and described herein as components and/or instructions separate from the memory 102 (e.g., operatively connected to the memory 102), the various aspects are not limited to this implementation. Instead, in accordance with various implementations, the one or more computer executable components and/or the one or more computer executable instructions may be stored in (or integrated within) the memory 102. Further, while various components and/or instructions have been illustrated as separate components and/or as separate instructions, in some implementations, multiple components and/or multiple instructions may be implemented as a single component or as a single instruction. Further, a single component and/or a single instruction may be implemented as multiple specialized components and/or as multiple instructions without departing from the example embodiments.

Referring to FIGS. 1 and 2, the pay return system 100 may also include a segment decision component 106. The segment decision component 106 utilizes a hierarchical segmentation structure that uses the PCD to assign each account to a risk segment 106-2 based on a value of decision variables 106-4. The risk segment assignment is an indication of initial risk and each risk segment 106-2 has within it similar risk rates. The segment decision component 106 evaluates a value of decision variables 106-4 and then performs a hierarchical IF-THEN iteration to assign the account into a risk segment 106-2. It is to be understood that the number of risk segments 106-2 may vary and thus, the innovation is not dependent on the number of risk segments. For example, as shown in FIG. 2, the number of risk segments 106-2 may vary from 1 to N risk segments. In addition, it is to be understood that the innovation is not dependent on the type of risk segment. Therefore, the example embodiment illustrated in the figures is for illustrative purposes only and is not intended to limit the scope of the innovation.

The decision variables 106-4 are dynamic numbers (or account indicators) that are related to the account and to account transaction activity. A value of each decision variable 106-4 is dependent on the transaction activity of the account. Thus, the values of the decision variable 106-4 are dynamic. It is to be understood that the innovation is not dependent on the number of decision variables 106-4. Thus, the number of decision variables 106-4 may vary based on factors, such as but not limited to, type of account, the consumer, etc.

Still referring to FIGS. 1 and 2, the pay return system 100 may also include a score calculation component 108. The score calculation component 108 calculates a daily risk score 108-2, which is a dynamic indicator that shows the overdraft risk for a particular account for a given day. The daily risk score 108-2 changes daily based on the value of each decision variable 106-4 described above. As will be described further below, the daily risk score 108-2 is calculated through a method of: 1) calculating a pre-defined model weight (i.e., regression coefficients) 106-6 for each decision variable 106-4, 2) multiplying the pre-defined model weight 106-6 for each decision variable 106-4 by the associated decision variable value to obtain a decision variable score, 3) summing the decision scores to obtain a sub-daily risk score 108-2, and 4) adding the sub-daily risk score to a numeric intercept value to obtain a daily risk score 108-2.

Calculating the pre-defined model weight 106-6 for each decision variable 106-4 is determined through a predictive modeling process. The predictive analytics and modeling provide, with a degree of certainty, the relationship between the decision variables 106-4 and how a value of one or more decision variables 106-4 is affected when one or more other decision variables 106-4 change. Once the predictive analytics determines the relationship between the decision variables, the pre-defined model weight 106-6 is assigned to each decision variable 106-4 and then is multiplied by the associated decision variable value, all these products are summed up and added to the numeric intercept to obtain the daily risk score 108-2.

Still referring to FIGS. 1 and 2, based on the daily risk score 108-2, an assignment component 110 assigns the account to a risk group 110-2 within the associated risk segment 106-2. The risk group assignment further defines the portfolio into even finer segments based on risk and usage characteristics, which allows more business opportunities to be captured through optimized tolerance assignments. The assignment component 110 assigns the accounts into risk groups 110-2 by comparing the daily risk score 108-2 of the account against a daily risk score threshold for each risk group.

The system and method 100 may further include an overdraft tolerance component 112 that assigns an overdraft tolerance 112-2 to each risk group 110-2 based on the matrix combining the risk segment 106-2 and the daily score threshold. Thus, once the account is assigned to the risk group 110-2, the overdraft tolerance 112-2 is assigned to that account. This configuration provides more control over overdraft tolerance assignments targeted to risk segments 106-2 and risk groups 110-2. Further, the overdraft tolerances 112-2 are dynamic and thus, change periodically (e.g., daily) based on the account transaction activity. In addition, the overdraft tolerance may include a minimum and a maximum amount. It is to be understood, however, that the number of risk groups is not fixed and may vary at predetermined time intervals (e.g., daily, weekly, monthly, annually, etc.) and thus, may be any number. For example, the number of risk groups may vary between 1 and any number X, as illustrated in FIG. 2. Therefore, the innovation is not dependent on the number of risk groups and as such, the example embodiments disclosed herein are for illustrative purposes only and are not intended to limit the scope of the innovation.

In addition, methods that may be implemented in accordance with the disclosed subject matter will be better appreciated with reference to the flow charts. While, for purposes of simplicity of explanation, the methods are shown and described as a series of blocks, it is to be understood and appreciated that the disclosed aspects are not limited by the number or order of blocks, as some blocks may occur in different orders and/or at substantially the same time with other blocks from what is depicted and described herein. Moreover, not all illustrated blocks may be required to implement the disclosed methods. It is to be appreciated that the functionality associated with the blocks may be implemented by software, hardware, a combination thereof, or any other suitable means (e.g. device, system, process, component, and so forth). Additionally, it should be further appreciated that the disclosed methods are capable of being stored on an article of manufacture to facilitate transporting and transferring such methods to various devices. Those skilled in the art will understand and appreciate that the methods might alternatively be represented as a series of interrelated states or events, such as in a state diagram.

The various aspects (e.g., in connection with automatic implementation of various portions of actions/events, completion of a prior action/event, and so forth) may employ various artificial intelligence-based schemes for carrying out various aspects thereof. For example, a process for determining if a particular action should follow a current action may be enabled through an automatic classifier system and process.

A classifier is a function that maps an input attribute vector, x=(x1, x2, x3, x4, xn), to a confidence that the input belongs to a class. In other words, f(x)=confidence (class). Such classification may employ a probabilistic and/or statistical-based analysis (e.g., factoring into the analysis utilities and costs) to prognose or infer an action that should be employed to determine what actions should be automatically performed and what actions should be performed after receiving confirmation from the user to proceed. In the case of actions/events, for example, attributes may be identification of a user device and/or the user and the classes are criteria related to known information (e.g., historical information) about the user device and/or user.

A support vector machine (SVM) is an example of a classifier that may be employed. The SVM operates by finding a hypersurface in the space of possible inputs, which hypersurface attempts to split the triggering criteria from the non-triggering events. Intuitively, this makes the classification correct for testing data that may be similar, but not necessarily identical to training data. Other directed and undirected model classification approaches (e.g., naïve Bayes, Bayesian networks, decision trees, neural networks, fuzzy logic models, and probabilistic classification models) providing different patterns of independence may be employed. Classification as used herein, may be inclusive of statistical regression that is utilized to develop models of priority.

One or more aspects may employ classifiers that are explicitly trained (e.g., through a generic training data) as well as classifiers that are implicitly trained (e.g., by observing fraud trends, by receiving extrinsic information, and so on). For example, SVM's may be configured through a learning or training phase within a classifier constructor and feature selection module. Thus, a classifier(s) may be used to automatically learn and perform a number of functions, including but not limited to determining according to a predetermined criteria when to provide a suggested action (e.g., take medication), when to complete a current action, which actions to implement in sequence, and so forth. The criteria may include, but is not limited to, historical information, user preferences, expected actions, and so forth.

Additionally or alternatively, an implementation scheme (e.g., a rule, a policy, and so on) may be applied to control and/or regulate events and resulting recommendations, subsequent events, and so forth. In some implementations, based upon a predefined criterion, the rules-based implementation may automatically and/or dynamically implement one or more portions of an event/action. In response thereto, the rule-based implementation may automatically interpret and carry out functions associated with the event/action by employing a predefined and/or programmed rule(s) based upon any desired criteria.

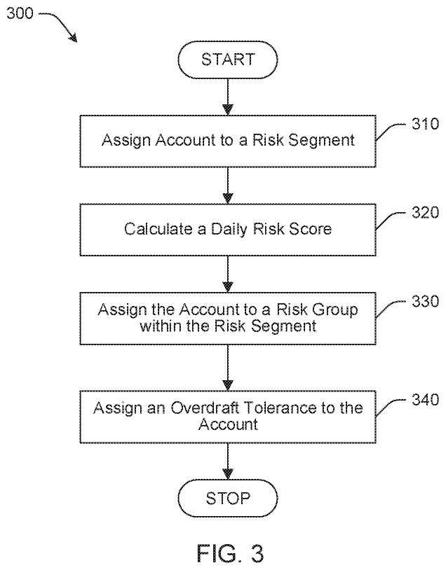

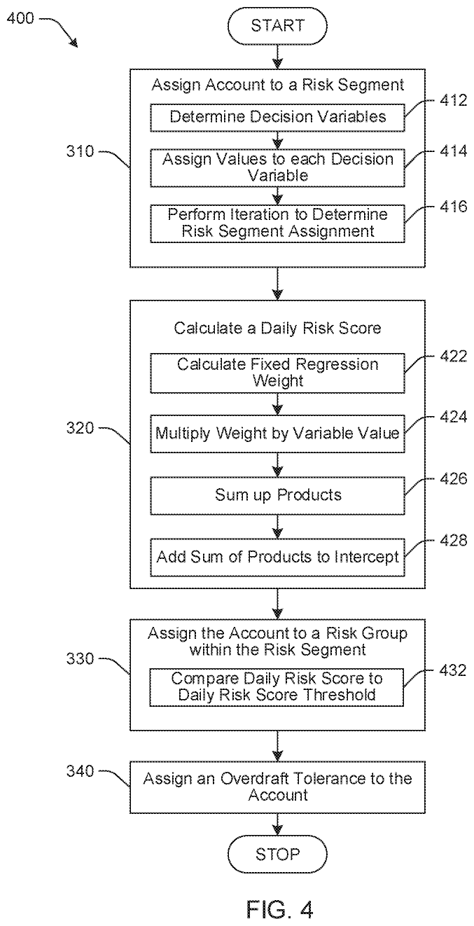

FIGS. 3 and 4 are non-limiting block diagram illustrations of the method of determining overdraft tolerances 300, 400 for qualifying DDAs in accordance with an aspect of the innovation. Referring to FIG. 3, at 310 an account is assigned to one of multiple risk segments. At 320, the daily risk score is calculated via a statistical method. At 330, the account is assigned to a risk group within the risk segment based on the daily score. At 340, an overdraft tolerance is assigned to the account.

Referring to FIG. 4, assigning the account to one of multiple risk segments (310) includes at 412, determining decision variables for the accounts that are used to calculate the daily risk score. At 414, values, described above, are assigned to each decision variable. At 416, an IF-THEN iteration is performed to determine which risk segment the account is assigned to.

Calculating the daily risk score (320) includes, at 422, calculating a pre-defined model weight for each decision variable via the predictive analytics described above. At 424, the pre-defined model weight for each decision variable value is multiplied by the associated decision variable value to obtain a decision variable score for each decision variable. At 426, the products of each decision variable score are added together to obtain a sub-daily risk score. At 428, the sub-daily risk score is added to a numeric intercept to achieve the daily risk score. Assigning the account to a risk group within the risk segment based on the daily score (330) includes, at 432, comparing the daily risk score to a daily risk score threshold.

It is to be understood, that the innovative system and method is not limited to qualifying retail DDAs. The innovation disclosed herein can be applied to most any type of bank account, such as commercial deposit accounts.

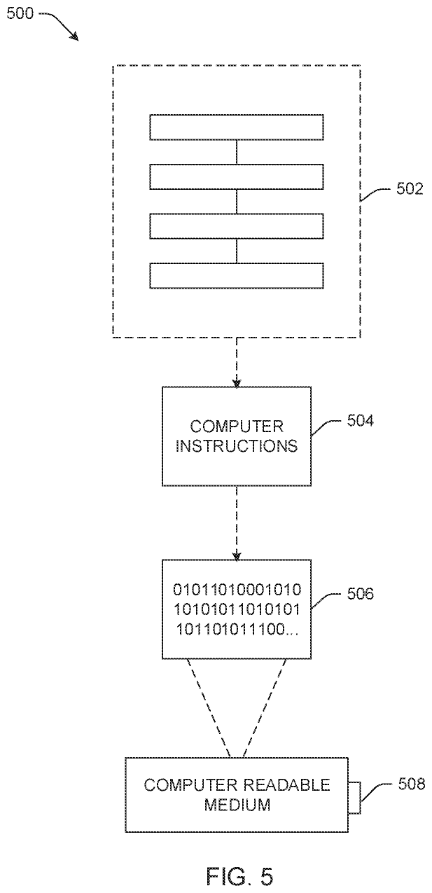

One or more implementations include a computer-readable medium including processor-executable instructions configured to implement one or more embodiments presented herein. An embodiment of a computer-readable medium or a computer-readable device devised in these ways is illustrated in FIG. 5, wherein an implementation 500 includes a computer-readable medium 502, such as a CD-R, DVD-R, flash drive, a platter of a hard disk drive, and so forth, on which is encoded computer-readable data 504. The computer-readable data 504, such as binary data including a plurality of zero's and one's as illustrated, in turn includes a set of computer instructions 506 configured to operate according to one or more of the principles set forth herein.

In the illustrated embodiment 500, the processor-executable computer instructions 806 may be configured to perform a method 508, such as the methods disclosed herein. In another embodiment, the processor-executable instructions 504 may be configured to implement a system, such as the systems disclosed herein. Many such computer-readable media may be devised by those of ordinary skill in the art that are configured to operate in accordance with the techniques presented herein.

As used in this application, the terms “component”, “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, or a computer. By way of illustration, both an application running on a controller and the controller may be a component. One or more components residing within a process or thread of execution and a component may be localized on one computer or distributed between two or more computers.

Further, the claimed subject matter may be implemented as a method, apparatus, or article of manufacture using standard programming or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

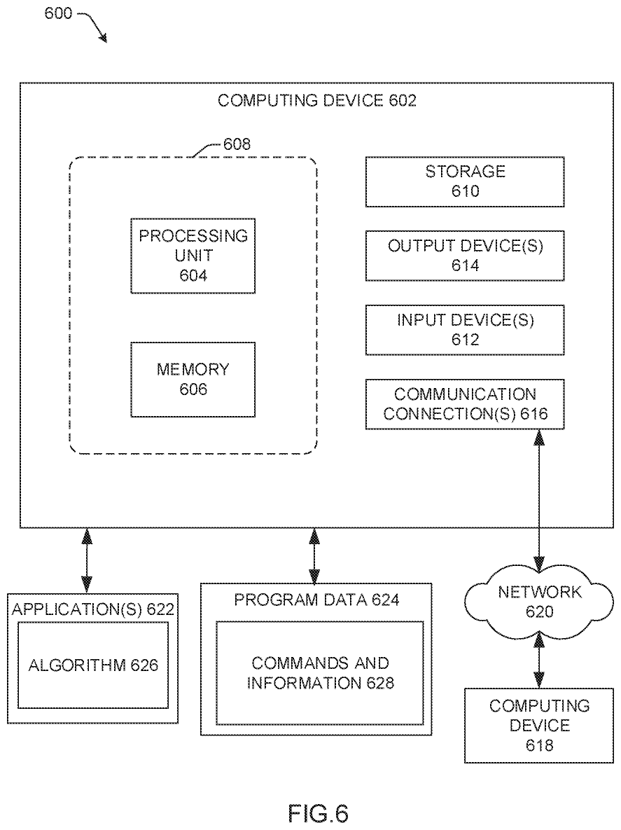

FIG. 6 and the following discussion provide a description of a suitable computing environment to implement embodiments of one or more of the aspects set forth herein. The operating environment of FIG. 6 is merely one example of a suitable operating environment and is not intended to suggest any limitation as to the scope of use or functionality of the operating environment. Example computing devices include, but are not limited to, personal computers, server computers, hand-held or laptop devices, mobile devices, such as mobile phones, Personal Digital Assistants (PDAs), media players, and the like, multiprocessor systems, consumer electronics, mini computers, mainframe computers, distributed computing environments that include any of the above systems or devices, etc.

Generally, embodiments are described in the general context of “computer readable instructions” being executed by one or more computing devices. Computer readable instructions may be distributed via computer readable media as will be discussed below. Computer readable instructions may be implemented as program modules, such as functions, objects, Application Programming Interfaces (APIs), data structures, and the like, that perform one or more tasks or implement one or more abstract data types. Typically, the functionality of the computer readable instructions are combined or distributed as desired in various environments.

FIG. 6 illustrates a system 600 that may include a computing device 602 configured to implement one or more embodiments provided herein. In one configuration, the computing device 602 may include at least one processing unit 604 and at least one memory 606. Depending on the exact configuration and type of computing device, the at least one memory 606 may be volatile, such as RAM, non-volatile, such as ROM, flash memory, etc., or a combination thereof. This configuration is illustrated in FIG. 6 by dashed line 608.

In other embodiments, the device 602 may include additional features or functionality. For example, the device 602 may include additional storage such as removable storage or non-removable storage, including, but not limited to, magnetic storage, optical storage, etc. Such additional storage is illustrated in FIG. 6 by storage 610. In one or more embodiments, computer readable instructions to implement one or more embodiments provided herein are in the storage 610. The storage 610 may store other computer readable instructions to implement an operating system, an application program, etc. Computer readable instructions may be loaded in at least one memory 606 for execution by the at least one processing unit 604, for example.

Computing devices may include a variety of media, which may include computer-readable storage media or communications media, which two terms are used herein differently from one another as indicated below.

Computer-readable storage media may be any available storage media, which may be accessed by the computer and includes both volatile and nonvolatile media, removable and non-removable media. By way of example, and not limitation, computer-readable storage media may be implemented in connection with any method or technology for storage of information such as computer-readable instructions, program modules, structured data, or unstructured data. Computer-readable storage media may include, but are not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or other tangible and/or non-transitory media which may be used to store desired information. Computer-readable storage media may be accessed by one or more local or remote computing devices (e.g., via access requests, queries or other data retrieval protocols) for a variety of operations with respect to the information stored by the medium.

Communications media typically embody computer-readable instructions, data structures, program modules, or other structured or unstructured data in a data signal such as a modulated data signal (e.g., a carrier wave or other transport mechanism) and includes any information delivery or transport media. The term “modulated data signal” (or signals) refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

The device 602 may include input device(s) 612 such as keyboard, mouse, pen, voice input device, touch input device, infrared cameras, video input devices, or any other input device. Output device(s) 614 such as one or more displays, speakers, printers, or any other output device may be included with the device 602. The input device(s) 612 and the output device(s) 614 may be connected to the device 602 via a wired connection, wireless connection, or any combination thereof. In one or more embodiments, an input device or an output device from another computing device may be used as the input device(s) 612 and/or the output device(s) 614 for the device 602. Further, the device 602 may include communication connection(s) 616 to facilitate communications with one or more other devices, illustrated as a computing device 618 coupled over a network 620.

One or more applications 622 and/or program data 624 may be accessible by the computing device 602. According to some implementations, the application(s) 622 and/or program data 624 are included, at least in part, in the computing device 602. The application(s) 622 may include an algorithm 626 that is arranged to perform the functions as described herein including those described herein. The program data 624 may include commands and information 628 that may be useful for operation with the system and method disclosed herein.

Although the subject matter has been described in language specific to structural features or methodological acts, it is to be understood that the subject matter of the appended claims is not necessarily limited to the specific features or acts described above. Rather, the specific features and acts described above are disclosed as example embodiments.

Various operations of embodiments are provided herein. The order in which one or more or all of the operations are described should not be construed as to imply that these operations are necessarily order dependent. Alternative ordering will be appreciated based on this description. Further, not all operations may necessarily be present in each embodiment provided herein.

As used in this application, “or” is intended to mean an inclusive “or” rather than an exclusive “or.” Further, an inclusive “or” may include any combination thereof (e.g., A, B, or any combination thereof). In addition, “a” and “an” as used in this application are generally construed to mean “one or more” unless specified otherwise or clear from context to be directed to a singular form. Additionally, at least one of A and B and/or the like generally means A or B or both A and B. Further, to the extent that “includes”, “having”, “has”, “with”, or variants thereof are used in either the detailed description or the claims, such terms are intended to be inclusive in a manner similar to the term “comprising”.

Further, unless specified otherwise, “first,” “second,” or the like are not intended to imply a temporal aspect, a spatial aspect, an ordering, etc. Rather, such terms are merely used as identifiers, names, etc. for features, elements, items, etc. For example, a first channel and a second channel generally correspond to channel A and channel B or two different or two identical channels or the same channel Additionally, “comprising,” “comprises,” “including,” “includes,” or the like generally means comprising or including.

Although the disclosure has been shown and described with respect to one or more implementations, equivalent alterations and modifications will occur based on a reading and understanding of this specification and the annexed drawings. The disclosure includes all such modifications and alterations and is limited only by the scope of the following claims.

1. A method comprising:
executing, on a processor, instructions that cause the processor to perform operations comprising;
computing a decision variable value for a plurality of decision variables related to an account and transaction activity of the account;
assigning the account to one of a plurality of risk segments based on the decision variable value, each risk segment of the plurality of risk segments comprises accounts with a similar initial risk indication;
invoking a predictive modeling process that determines a relationship between decision variables and a pre-defined model weight for each decision variable;
computing a dynamic daily risk score for the account based on the pre-defined model weight for each of the plurality of decision variables and corresponding decision variable values;
assigning the account to one of a plurality of risk groups in the assigned risk segment of the plurality of risk segments based on a result of a comparison between the dynamic daily risk score to a daily risk score threshold for each of the plurality of risk groups;
assigning an overdraft tolerance to the account based on the assigned risk group of the plurality of risk groups; and
controlling transaction payment from the account in overdraft based on the overdraft tolerance assigned to the account.

2. (canceled)

3. The method of claim 1 further comprising performing an IF-THEN iteration to determine to which risk segment the account is assigned.

4. The method of claim 1, wherein calculating the daily risk score for the account includes multiplying the decision variable value by the pre-defined model weight to obtain a decision variable score for an associated decision variable from the plurality of decision variables.

5. The method of claim 4, wherein calculating the daily risk score for the account further includes summing each of the decision variable scores and adding a numeric intercept value.

6. The method of claim 1, wherein the plurality of decision variables are dynamic.

7. The method of claim 1, wherein each one of the plurality of risk groups within one of the plurality of risk segments has similar risk rates.

8. The method of claim 1, wherein assigning the account to one of a plurality of risk segments includes creating an hierarchical IF-THEN iteration using process control data.

9. (canceled)

10. The method of claim 1, wherein the overdraft tolerance is dynamic.

11. A system comprising:
a processor that executes the following computer executable components stored in a memory:
a segment decision component that computes a decision variable value for a plurality of decision variables related to a bank account and transaction activities of the bank account and assigns the bank account to one of a plurality of risk segments based on the decision variable, each risk segment of the plurality of risk segments comprises accounts with a similar initial risk indication;
a score calculation component that invokes a predictive modeling process that determines a relationship between decision variables and a pre-defined model weight for each decision variable and computes a periodic risk score for the bank account based on the pre-defined model weight for each decision variable and corresponding decision variable values;
an assignment component that assigns the bank account to one of a plurality of risk groups within the assigned risk segment of the plurality of risk segments based on a result of a comparison between the periodic risk score and a daily risk score threshold; and
an overdraft tolerance component that assigns an overdraft tolerance to the bank account based on the assigned risk group of the plurality of risk groups and controls transaction payment from the bank account in overdraft based on the assigned overdraft tolerance.

12. The system of claim 11, wherein the segment decision further performs a hierarchical IF-THEN iteration to assign the bank account into the one of the plurality of risk segments.

13. The system of claim 12, wherein computing the periodic risk score further comprises computing a decision variable score, wherein computing the decision variable score includes multiplying the decision variable value of each of the plurality of decision variables by a pre-defined model weight for an associated decision variable from the plurality of decision variables to obtain a decision variable score for an associated decision variable from the plurality of decision variables.

14. The system of claim 13, wherein the score calculation component further sums up the decision variable scores and adds a numeric intercept value to the sum to obtain the periodic risk score for the bank account.

15. The system of claim 11, wherein the segment decision component utilizes a hierarchical IF-THEN iteration using process control data to assign the bank account to the one of the plurality of risk segments.

16. (canceled)

17. A computer-readable storage device storing executable instructions that, in response to execution, cause a system comprising a processor to perform operations, comprising:
computing a decision variable value for a plurality of decision variables associated with a qualifying demand deposit account (DDA);
assigning the qualifying DDA to one of a plurality of risk segments by performing an IF-THEN iteration to the plurality of decision variables;
invoking a predictive modeling process that determines a relationship between the decision variable and a pre-defined model weight for each of the plurality of decision variables;
computing a decision variable score for each of the plurality of decision variables by multiplying the pre-defined model weight by the decision variable value of an associated decision variable from the plurality of decision variables;
summing the decision variable score for each of the plurality of decision variables;
adding a numeric intercept to the sum of the decision variable score for each of the plurality of decision variables thereby determining a daily risk score;
comparing the daily risk score to a daily risk score threshold;
assigning the qualifying DDA to one of a plurality of risk groups within the one of the plurality of risk segments based on the comparison of the daily risk score and the daily risk score threshold;
assigning an overdraft tolerance to the qualifying DDA based on the assigned risk group of the plurality of risk groups; and
controlling transaction payment from the qualifying DDA based on the assigned overdraft tolerance.

18. (canceled)

19. The computer-readable storage device of claim 17, wherein the daily risk score is dynamic.

20. The computer-readable storage device of claim 17, wherein the overdraft tolerance is dynamic.
